(19) United States
(12) Patent Application Publication
(10) Pub. No.: US 2017/0107333 A1
(43) Pub. Date: Apr. 20, 2017

(54) MANUFACTURE METHOD OF GRAPHENE BASED RESIN PELLET AND MANUFACTURE METHOD OF CONDUCTIVE SEAL

(71) Applicant: Shenzhen China Star Optoelectronics Technology Co., Ltd., Shenzhen City (CN)

(72) Inventors: Tao Hu, Shenzhen City (CN); Yahui Chen, Shenzhen City (CN); Yungjui Lee, Shenzhen City (CN)

(73) Assignee: Shenzhen China Star Optoelectronics Technology Co. , Ltd., Shenzhen City, Guangdong (CN)

(21) Appl. No.: 14/777,519

(22) PCT Filed: Jun. 18, 2015
(86) PCT No.: PCT/CN2015/081724

§ 371 Date: Sep. 16, 2015

(30) Foreign Application Priority Data
May 7, 2015 (CN) 201510230420.3

(51) Int. Cl. C08J 3/12; C08J 3/215; C09J 157/06; C09J 11/04; C09J 125/06; C08K 3/04; C09J 9/02

(52) U.S. Cl. CPC C08J 3/12; C08K 3/04; C08J 3/215; C09J 9/02; C09J 11/04; C09J 125/06; C09J 157/06; C08K 2201/001; C08J 2325/06; C08J 2357/06

(57) ABSTRACT

The present invention provides a manufacture method of a graphene based resin pellet and a manufacture method of conductive seal. The present invention provides a manufacture method of a graphene based resin pellet, which employs green environmental protection flashing light for deoxidizing graphene oxide with an exposure method. The process is simple and easy to control. The method can be utilized for mass production. The present invention provides a manufacture method of conductive seal, which utilizes the graphene based resin pellet to be a conductive particle for replacing the conductive gold ball commonly used in the conductive seal according to prior art, and the process of manufacturing graphene based resin pellet in the method is green environmental protective to prevent the heavy metal pollution problem during the production procedure of the conductive gold ball; the graphene oxide used for manufacturing the graphene based resin pellet is effective presoma of massively manufacturing graphene material, and the source is widely available and the production cost can be effectively reduced.

### FIELD OF THE INVENTION

The present invention relates to a flat panel display field, and more particularly to a manufacture method of a graphene based resin pellet and a manufacture method of conductive seal.

### BACKGROUND OF THE INVENTION

At present, in the Liquid Crystal Display (LCD) industry, the seal mixed with conductive gold balls (Au ball) are commonly utilized for conducting the upper, lower substrates. As the substrates are laminated, the outer gold/nickel wrapping layer of the conductive gold balls can transmit electrons (the electroconductibility demand reaches 2.4×10⁵ S/cm), and the inner cores of the conductive gold balls comprises elastic resin pellets to ease the stress after lamination. The production of traditional conductive gold balls is to use the chemical plating method to wrap gold/nickel on the surface of the resin pellets with 5-8 μm diameters. The method cost a lot energy. In the procedure, the heavy metal pollution happens and the price of the gold is expensive and the cost increases.

The graphene possesses excellent electron conductibility (electroconductibility is about 10⁶ S/cm), excellent mechanical property and fine flexibility (Young modulus is about 1060 GPa, and breakdown strength is 130 GPa), stable chemical property. It can replace the gold/nickel to be wrapped on the surface of the resin pellets to form graphene based resin pellets with excellent electrical conductivity. It does not only conduct the upper, lower substrates, and the graphene sheets, of which the heat conductivity is outstanding (the heat conductivity is up to 5300 W/m/K) also can promote the heating curing efficiency to make the curing more uniform. Therefore, how to wrap the resin pellets with graphene well has become the key of manufacturing the graphene based resin pellets. Because the Van der Waals function among the graphene nano sheets, the graphene sheets can easily complex-precipitated in the aqueous solution and is difficultly dispersed to form the graphene solution with higher solid content. When it is mixed with the better dispersed resin pellet solution, it cannot effectively wrap the resin pellets. Generally, the surface treatment, such as acidation or addition of surface active agent is to improve the dispersity of the graphene solution. However, on one hand, the solid content of the obtained dispersed graphene solution remains to be low and the cost increases; on the other hand, these treatments, such as acidation will destroy the electron conductivity of the surface of the graphene nano sheets, and the addition of surface active agent, which does not conduct electricity will seriously reduce the electron conduction ability of the graphene complex material.

The graphene oxide is generally obtained by with ultrasonic process after utilizing chemical oxidation to strip graphene sheets. With the function of the strong oxidant, a great amount of oxygen groups, such as epoxy groups, OH groups, carboxyl groups are generated around and near the surfaces and of the graphene oxide nano sheets. Based on the repelling forces among the molecules, the water molecules can easily permeate into the respective nano sheets of the graphene oxide to make them possess high hydrophily. With simple ultrasonic, the graphene oxide solution can be easily obtained with stripping single layer or few layers layer by layer and the solid content is controllable. With profit from the electron absorption of these oxygen groups and the Van der Waals forces of the graphene oxide nano sheets, the graphene oxide nano sheets can form stable complex structures with many chemical compounds, such as oxides, organic resin materials, and thus to form the effective presoma of manufacturing the graphene based complex material liquid phase. For the resin pellets of proper sizes (the particle size range is 1-10 μm, and the resin pellets can be polymer micro balls, such as polystyrene or polyacrylic resin), the graphene oxide nano sheets can wrap the surfaces of the resin pellets to form stable core-shell structures. However, the oxygen functional groups of these graphene oxides will cause the bad electrical conductivity of the graphene oxide, and thus seriously affect the application of the graphene oxide compound in the aspect of conductive material. Thus, how to effectively use the method of industrial application to deoxidize the graphene oxide to be graphene is the hot agenda of the present researches.

For promoting the electrical conductivity of the graphene oxide, it is common to utilize the chemical deoxidizer (hydrogen sulfide, hydrazine, hydroquinone, caustic soda, caustic potash, aluminite powder) to deoxidize the graphene oxide. However, the process requires longer time. The chemical reagent, such as hydrazine hydrate is deadly poisonous and not suitable for mass production; besides, the thermal shock (900-1100° C.) can be utilized for removing the oxygen groups but such method cost higher energy. The other part in the complex material can be damaged at high temperature. As an illustration, the resin pellets can be decomposed and dissociated at high temperature.

### SUMMARY OF THE INVENTION

An objective of the present invention is to provide a manufacture method of a graphene based resin pellet, which employs green environmental protection flashing light for deoxidizing graphene oxide with an exposure method. The process is simple and easy to control. The method can be utilized for mass production.

An objective of the present invention is to provide a manufacture method of conductive seal, which utilizes the graphene based resin pellet to be a conductive particle for replacing the conductive gold ball commonly used in the conductive seal according to prior art, and the process of manufacturing graphene based resin pellet in the method is green environmental protective to prevent the heavy metal pollution problem during the production procedure of the conductive gold ball; the graphene oxide used for manufacturing the graphene based resin pellet is effective presoma of massively manufacturing graphene material, and the source is widely available and the production cost can be effectively reduced.

For realizing the aforesaid objectives, the present invention provides a manufacture method of a graphene based resin pellet, comprising steps of:

step 1, preparing graphene oxide solution of 0.1-5 mg/ml and resin pellet solution of 1-10 mg/ml, and mixing the graphene oxide solution of 0.1-5 mg/ml and the resin pellet solution of 1-10 mg/ml, and after magnetic stirring with 5 min-1 h, mixed solution is obtained, and ultrasonic processing the mixed solution with 5 min-2 h to obtain graphene oxide based resin pellet solution;

step 2, filtering the graphene oxide based resin pellet solution, and drying filter residue obtained after filtering in air with 60° C.-100° C., 0.5 h-4 h for completely removing water to obtain cinnamon graphene oxide based resin pellet powder;

step 3, employing a flashing light to implement exposure reduction to the graphene based resin pellet powder for deoxidizing graphene oxide wrapping up resin pellet surface to be graphene to obtain graphene based resin pellet.

In the step 1, the resin pellet solution is manufactured by dispersing resin pellets in aqueous solution with ultrasonic process.

In the step 1, material of the resin pellets is polystyrene or polyacrylic resin, and a particle size range of the resin pellets is 1-10 μm.

In the step 2, a suction filtration device is employed for filtering the graphene oxide based resin pellet solution.

In the step 1, a period of the magnetic stirring is 10 min, and a period of the ultrasonic processing is 30 min; in the step 2, the filter residue obtained after filtering is dried in air with 80° C., 2 h.

In the step 3, an exposure energy range of the flashing light is 0.5-3 J/cm².

In the step 3, in exposure procedure, as the graphene oxide based resin pellet powder becomes black with crackling sound, the exposure is intermitted for stirring the powder, and the exposure continues, and the exposure and the stirring are repeated with multiple times until no crackling sound, and reduction of the graphene oxide based resin pellet powder is accomplished.

The present invention further provides a manufacture method of a graphene based resin pellet, comprising steps of:

step 1, preparing graphene oxide solution of 0.1-5 mg/ml and resin pellet solution of 1-10 mg/ml, and mixing the graphene oxide solution of 0.1-5 mg/ml and the resin pellet solution of 1-10 mg/ml, and after magnetic stirring with 5 min-1 h, mixed solution is obtained, and ultrasonic processing the mixed solution with 5 min-2 h to obtain graphene oxide based resin pellet solution;

step 2, filtering the graphene oxide based resin pellet solution, and drying filter residue obtained after filtering in air with 60° C.-100° C., 0.5 h-4 h for completely removing water to obtain cinnamon graphene oxide based resin pellet powder;

step 3, employing a flashing light to implement exposure reduction to the graphene oxide based resin pellet powder for deoxidizing graphene oxide wrapping up resin pellet surface to be graphene to obtain graphene based resin pellet;

wherein in the step 1, the resin pellet solution is manufactured by dispersing resin pellets in aqueous solution with ultrasonic process;

wherein in the step 1, material of the resin pellets is polystyrene or polyacrylic resin, and a particle size range of the resin pellets is 1-10 μm;

wherein in the step 2, a suction filtration device is employed for filtering the graphene oxide based resin pellet solution.

The present invention further provides a manufacture method of conductive seal, comprising steps of:

step 10, employing the aforesaid manufacture method of the graphene based resin pellet to manufacture the graphene based resin pellet;

step 20, mixing, stirring and defoaming the graphene based resin pellets and seal to accomplish a glue mixing procedure for obtaining conductive seal.

In the step 20, the graphene based resin pellets and the seal are mixed with a mass ratio of 1:40.

In the step 20, after the graphene based resin pellets and the seal are mixed, the mixture is put in a glue mixing barrel, and the glue mixing barrel is positioned inside a rotator which can rotate and revolve to implement stirring and defoaming procedures.

In comparison with prior arts, the manufacture method of the graphene based resin pellet provided by the present invention possesses advantages below:
(1) The present invention employs green environmental protection flashing light for deoxidizing graphene oxide with a exposure method, and the process is simple and easy to control and can be utilized for mass production, and the wide application of the graphene based resin pellet employed to be conductive particles in the conductive seal constructs effective technical guarantee;
(2) The graphene based resin pellet manufactured by the present invention cannot merely be applied in the conductive seal for packaging the liquid crystal panel, but also can be applied in the conductive material such as the anisotropic conductive paste (ACP) and the anisotropic conductive film (ACF), which have been widely used in the semiconductor industry. Therefore, it has the huge commercial development value and the tremendous market application prospect.

In comparison with prior arts, the manufacture method of the conductive seal provided by the present invention possesses advantages below:
(I) the graphene based resin pellet is utilized to be a conductive particle for replacing the conductive gold ball commonly used in the conductive seal according to prior art to prevent the heavy metal pollution problem during the production procedure of the conductive gold ball;
(II) the process of manufacturing graphene based resin pellet in the method is green environmental protective and is simple and easy to control;
(III) the graphene oxide used for manufacturing the graphene based resin pellet is effective presoma of massively manufacturing graphene material, and the source is widely available and the production cost can be effectively reduced.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a flowchart of a manufacture method of a graphene based resin pellet according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

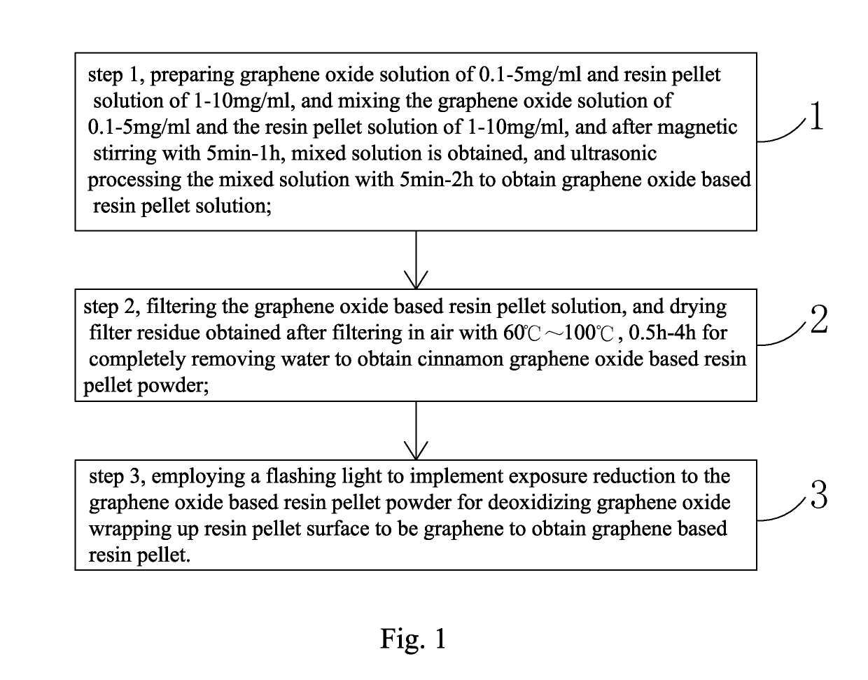

Please refer to FIG. 1. The present invention first provides a manufacture method of a graphene based resin pellet, comprising steps of:

step 1, preparing graphene oxide solution of 0.1-5 mg/ml and resin pellet solution of 1-10 mg/ml, and mixing the graphene oxide solution of 0.1-5 mg/ml and the resin pellet solution of 1-10 mg/ml, and after magnetic stirring with 5 min-1 h, mixed solution is obtained, and ultrasonic processing the mixed solution with 5 min-2 h to obtain graphene oxide based resin pellet solution.

It can be observed that the graphene oxide based resin pellet solution has well dispersity. Then, with the function of the hydroxyl group of the graphene oxide surface, the flexible graphene oxide sheets can closely wrap up the resin pellet.

The resin pellet solution is manufactured by dispersing resin pellets in aqueous solution with ultrasonic process.

Specifically, material of the resin pellets is polystyrene or polyacrylic resin, and a particle size range of the resin pellets is 1-10 μm, and preferably, the particle size range of the resin pellets is 5-8 μm.

Preferably, in the step 1, a period of the magnetic stirring is 10 min and a period of the ultrasonic processing is 30 min.

step 2, filtering the graphene oxide based resin pellet solution with a suction filtration device, and drying filter residue obtained after filtering in air with 60° C.-100° C., 0.5 h-4 h for completely removing water to obtain cinnamon graphene oxide based resin pellet powder.

Preferably, in the step 2, the filter residue obtained after filtering is dried in air with 80° C., 2 h.

step 3, employing a flashing light to implement exposure reduction to the graphene oxide based resin pellet powder for deoxidizing graphene oxide wrapping up resin pellet surface to be graphene to obtain graphene based resin pellet.

wherein the flashing light can be a common flashing light, and an exposure energy range of the flashing light is 0.5-3 J/cm²;

In exposure procedure, as the graphene oxide based resin pellet powder becomes black with crackling sound, for making the reaction more thorough, the exposure can be intermitted for stirring the powder, and then, the exposure continues, and the exposure and the stirring are repeated with multiple times until no crackling sound, and reduction of the graphene oxide based resin pellet powder is accomplished to obtain the graphene based resin pellet.

The present invention provides a manufacture method of a graphene based resin pellet, which employs green environmental protection flashing light for deoxidizing graphene oxide with an exposure method. The process is simple and easy to control. The method can be utilized for mass production.

The graphene based resin pellet manufactured by the present invention cannot merely be applied in the conductive seal for packaging the liquid crystal panel, but also can be applied in the conductive material such as the anisotropic conductive paste (ACP) and the anisotropic conductive film (ACF), which have been widely used in the semiconductor industry. Therefore, it has the huge commercial development value and the tremendous market application prospect.

The present invention further provides a manufacture method of conductive seal, comprising steps of:

step 10, employing the aforesaid manufacture method of the graphene based resin pellet to manufacture the graphene based resin pellet;

step 20, mixing, stirring and defoaming the graphene based resin pellets and seal to accomplish a glue mixing procedure for obtaining conductive seal.

Specifically, in the step 20, the graphene based resin pellets and the seal are mixed with a mass ratio of 1:40, and then, the mixture is put in a glue mixing barrel, and the glue mixing barrel is positioned inside a rotator which can rotate and revolve to implement stirring and defoaming procedures.

The present invention provides a manufacture method of conductive seal, which utilizes the graphene based resin pellet to be a conductive particle for replacing the conductive gold ball commonly used in the conductive seal according to prior art to prevent the heavy metal pollution problem during the production procedure of the conductive gold ball; the process of manufacturing graphene based resin pellet in the method is green environmental protective and is simple and easy to control; the graphene oxide used for manufacturing the graphene based resin pellet is effective presoma of massively manufacturing graphene material, and the source is widely available and the production cost can be effectively reduced.

Furthermore, the present invention provides a method of package a liquid crystal display panel with the conductive seal manufactured by the aforesaid method, of which the specific operation is:

providing a color filter substrate and an array substrate, and dispensing glue on the color filter substrate or the array substrate with apparatus and oppositely assembling and laminating the color filter substrate or the array substrate together, and heating and curing the conductive seal to obtain the liquid crystal display panel packaged by the conductive seal having graphene based resin pellets, and in the liquid crystal display panel, the color filter substrate or the array substrate are connected with the conductive seal;

in the procedure of heating and curing the conductive seal, with the excellent heat conduction ability of the graphene sheets of the graphene based resin pellets, the curing efficiency of the conductive seal can be promoted to make the curing more uniform; besides, with the excellent mechanical property, the stress of laminating the upper, lower substrates can be effectively eased for supporting the upper, lower substrates well and maintaining the gap stability between the substrates to ensure the consistency of the liquid crystal cell gap and reduce the appearance of the edge Mura.

In conclusion, the present invention provides a manufacture method of a graphene based resin pellet, which employs green environmental protection flashing light for deoxidizing graphene oxide with an exposure method. The process is simple and easy to control. The method can be utilized for mass production. The present invention provides a manufacture method of conductive seal, which utilizes the graphene based resin pellet to be a conductive particle for replacing the conductive gold ball commonly used in the conductive seal according to prior art, and the process of manufacturing graphene based resin pellet in the method is green environmental protective to prevent the heavy metal pollution problem during the production procedure of the conductive gold ball; the graphene oxide used for manufacturing the graphene based resin pellet is effective presoma of massively manufacturing graphene material, and the source is widely available and the production cost can be effectively reduced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a graphene based resin pellet, comprising steps of:
step 1, preparing graphene oxide solution of 0.1-5 mg/ml and resin pellet solution of 1-10 mg/ml, and mixing graphene oxide solution of 0.1-5 mg/ml and the resin pellet solution of 1-10 mg/ml, and after magnetic stirring with 5 min-1 h, mixed solution is obtained, and ultrasonic processing the mixed solution with 5 min-2 h to obtain graphene oxide based resin pellet solution;
step 2, filtering the graphene oxide based resin pellet solution, and drying filter residue obtained after filtering in air with 60° C.-100° C., 0.5 h-4 h for completely removing water to obtain cinnamon graphene oxide based resin pellet powder;
step 3, employing a flashing light to implement exposure reduction to the graphene oxide based resin pellet powder for deoxidizing graphene oxide wrapping up resin pellet surface to be graphene to obtain graphene based resin pellet.

2. The manufacture method of the graphene based resin pellet according to claim 1, wherein in the step 1, the resin pellet solution is manufactured by dispersing resin pellets in aqueous solution with ultrasonic process.

3. The manufacture method of the graphene based resin pellet according to claim 1, wherein in the step 1, material of the resin pellets is polystyrene or polyacrylic resin, and a particle size range of the resin pellets is 1-10 μm.

4. The manufacture method of the graphene based resin pellet according to claim 1, wherein in the step 2, a suction filtration device is employed for filtering the graphene oxide based resin pellet powder.

5. The manufacture method of the graphene based resin pellet according to claim 1, wherein in the step 1, a period of the magnetic stirring is 10 min, and a period of the ultrasonic processing is 30 min; in the step 2, the filter residue obtained after filtering is dried in air with 80° C., 2 h.

6. The manufacture method of the graphene based resin pellet according to claim 1, wherein in the step 3, an exposure energy range of the flashing light is 0.5-3 J/cm².

7. The manufacture method of the graphene based resin pellet according to claim 1, wherein in the step 3, in exposure procedure, as the graphene oxide based resin pellet powder becomes black with crackling sound, the exposure is intermitted for stirring the powder, and the exposure continues, and the exposure and the stirring are repeated with multiple times until no crackling sound, and reduction of the graphene oxide based resin pellet powder is accomplished.

8. A manufacture method of a graphene based resin pellet, comprising steps of:
step 1, preparing graphene oxide solution of 0.1-5 mg/ml and resin pellet solution of 1-10 mg/ml, and mixing graphene oxide solution of 0.1-5 mg/ml and the resin pellet solution of 1-10 mg/ml, and after magnetic stirring with 5 min-1 h, mixed solution is obtained, and ultrasonic processing the mixed solution with 5 min-2 h to obtain graphene oxide based resin pellet solution;
step 2, filtering the graphene oxide based resin pellet solution, and drying filter residue obtained after filtering in air with 60° C.-100° C., 0.5 h-4 h for completely removing water to obtain cinnamon graphene oxide based resin pellet powder;
step 3, employing a flashing light to implement exposure reduction to the graphene oxide based resin pellet powder for deoxidizing graphene oxide wrapping up resin pellet surface to be graphene to obtain graphene based resin pellet;
wherein in the step 1, the resin pellet solution is manufactured by dispersing resin pellets in aqueous solution with ultrasonic process;
wherein in the step 1, material of the resin pellets is polystyrene or polyacrylic resin, and a particle size range of the resin pellets is 1-10 μm;
wherein in the step 2, a suction filtration device is employed for filtering the graphene oxide based resin pellet solution.

9. The manufacture method of the graphene based resin pellet according to claim 8, wherein in the step 1, a period of the magnetic stirring is 10 min, and a period of the ultrasonic processing is 30 min; in the step 2, the filter residue obtained after filtering is dried in air with 80° C., 2 h.

10. The manufacture method of the graphene based resin pellet according to claim 8, wherein in the step 3, an exposure energy range of the flashing light is 0.5-3 J/cm².

11. The manufacture method of the graphene based resin pellet according to claim 8, wherein in the step 3, in exposure procedure, as the graphene oxide based resin pellet powder becomes black with crackling sound, the exposure is intermitted for stirring the powder, and the exposure continues, and the exposure and the stirring are repeated with multiple times until no crackling sound, and reduction of the graphene oxide based resin pellet powder is accomplished.

12. A manufacture method of conductive seal, comprising steps of:
step 10, employing the manufacture method of the graphene based resin pellet according to claim 1 to manufacture the graphene based resin pellet;
step 20, mixing, stirring and defoaming the graphene based resin pellets and seal to accomplish a glue mixing procedure for obtaining conductive seal.

13. The manufacture method of conductive seal according to claim 12, wherein in the step 20, the graphene based resin pellets and the seal are mixed with a mass ratio of 1:40.

14. The manufacture method of conductive seal according to claim 12, wherein in the step 20, after the graphene based resin pellets and the seal are mixed, the mixture is put in a glue mixing barrel, and the glue mixing barrel is positioned inside a rotator which can rotate and revolve to implement stirring and defoaming procedures.
